(19) United States
(12) Patent Application Publication
(10) Pub. No.: US 2005/0193375 A1
(43) Pub. Date: Sep. 1, 2005

(54) Software monitoring system for the polling of processes to determine the presently executing function

(76) Inventor: Matthew Donald Larson, Littleton, CO (US)

Correspondence Address: PATTON BOGGS, 1660 LINCOLN ST, SUITE 2050, DENVER, CO, 80264, US

(21) Appl. No.: 10/789,131

(22) Filed: Feb. 27, 2004

(51) Int. Cl. G06F 9/44

(52) U.S. Cl. 717/127

(57) ABSTRACT

The function polling system both uses the proprietary reporting Application Interface of the software application, as needed, while also bypassing the proprietary reporting Application Interface to directly poll the executing software application to perform a time-wise snapshot of the executing software application to thereby limit the amount of data generated, yet provide a more comprehensive view of the executing software application. The function polling system periodically checks the software application to determine which function is presently executing within the software application. The periodic polling of executing processes significantly reduces the amount of data collected, yet enables the application stakeholder to obtain a granularity of data relating to the executing software application not available with existing software monitoring systems. The function polling system monitors all the functions embodied in the software application rather than selected functions to thereby avoid gaps in the coverage of the monitoring.

### FIELD OF THE INVENTION

This invention relates to software monitoring systems that function to track the present state of the software applications that are executing on a processor.

### Problem

It is a problem in the field of computer systems to monitor the operation of the various software applications that are presently executing on a processor to collect, organize, and report information to the application stakeholder (which term identifies individuals responsible for the performance and availability of the application as well as the users of the application) to enable that individual to tune and optimize the operation of the processor, and more particularly, the monitored software applications.

Existing software applications typically have a proprietary reporting Application Interface (API) that produces only a small fraction of the reporting data that is possible. The software application generates a vast amount of data that can be used to monitor the operation of both the processor with its components, and the software application, as well as all of the functions that are used to implement the software application. The set of reporting statistics provided to the application stakeholder by the proprietary reporting Application Interface is selected by the developer of the software application and may not be the most relevant information for the present needs of the application stakeholder. In order to address this problem, there is a suite of software reporting applications, provided by third parties, which function to take the data produced by the selected set of reporting statistics, modify this data and generate reports for the application stakeholder. However, this paradigm simply compounds the problems inherent in the proprietary reporting Application Interface by further limiting the application stakeholder's view of the system through the conversion of the data produced by the selected set of reporting statistics into a different form or even a reduced, less specific set of information. This simply serves to further reduce the application stakeholder's access to data that may be relevant.

An alternative to the use of third party software reporting applications is the tracing all of the statistics generated by executing software applications in order to obtain a complete picture of the operation of the software application. However, the software application typically produces a huge amount of data, which does not assist the application stakeholder since this data must be processed into some focused set of reports. The presentation of volumes of raw data, while presenting the most complete picture of the execution of the software application, creates a separate set of problems, no less significant that those created by the proprietary reporting Application Interface.

Thus, existing software monitoring systems that function to track the present state of a software application that is executing on a processor either generate excessive amounts of raw data or rely on the production of predefined reports based on statistics reported by proprietary reporting Application Interfaces, which produces limited useful data.

### Solution

The above described problems are solved and a technical advance achieved in the field by the present software monitoring system for the polling of processes to determine the presently executing function (termed “function polling system” herein) which functions to monitor the execution of virtually any software application. This function polling system is capable of monitoring any executing software application and collects all of the needed information from the monitored software application, not just the proprietary reporting Application Interface. The function polling system includes software specific modules that translate the collected information into terms that relate to the specific software application and which make sense to a application stakeholder.

The present function polling system overcomes the problems found in existing software monitoring approaches by both using the proprietary reporting Application Interface of the software application, as needed, while also bypassing the proprietary reporting Application Interface to directly poll the executing software application to perform a time-wise snapshot of the executing software application to thereby limit the amount of data generated, yet provide a more comprehensive view of the executing software application. The function polling system periodically checks the software application to determine which function is presently executing within the software application. The periodic polling of executing processes significantly reduces the amount of data collected, yet enables the application stakeholder to obtain a granularity of data relating to the executing software application not available with existing software monitoring systems. The function polling system monitors all the functions embodied in the software application rather than selected functions to thereby avoid gaps in the coverage of the monitoring.

### BRIEF DESCRIPTION OF THE DRAWINGS

FIG. 1 illustrates, in block diagram form, the overall architecture of the present function polling system and a typical operating environment;

FIG. 2 illustrates, in block diagram form, the capabilities of existing software application monitoring systems;

FIG. 3 illustrates, in block diagram form, the capabilities of the present function polling system; and

FIG. 4 illustrates, in block diagram form, the operating architecture of the function polling system as compared to existing conventional monitoring repositories.

### DETAILED DESCRIPTION

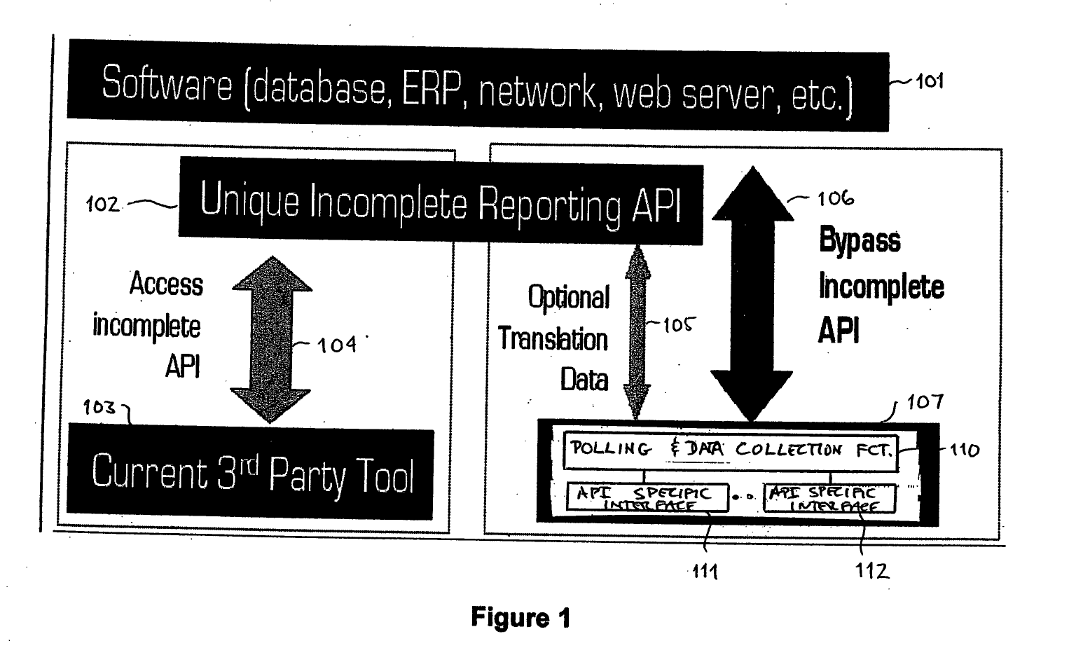

FIG. 1 illustrates, in block diagram form, the overall architecture of the present function polling system 107 and a typical operating environment. Existing software applications 101 typically have a proprietary reporting Application Interface (API) 102 that produces only a small fraction of the reporting data that is possible. The software application 101 generates a vast amount of data that can be used to monitor the operation of both the processor with its components, and the software application 101, as well as all of the functions that are used to implement the software application 101. The set of reporting statistics 104 provided to the application stakeholder by the proprietary reporting Application Interface 102 is selected by the developer of the software application and may not be the most relevant information for the present needs of the application stakeholder. In order to address this problem, there is a suite of software reporting applications 103, provided by third parties, which function to take the data produced by the selected set of reporting statistics, modify this data and generate reports for the application stakeholder. However, this paradigm simply compounds the problems inherent in the proprietary reporting Application Interface 102 by further limiting the application stakeholder's view of the system through the conversion of the data produced by the selected set of reporting statistics into a different form or even a reduced, less specific set of information. This simply serves to further reduce the application stakeholder's access to data that may be relevant.

The present function polling system 107 overcomes the problems found in existing software monitoring approaches by both using the proprietary reporting Application Interface 102 of the software application 101, as needed, while also bypassing the proprietary reporting Application Interface 102 to directly poll the executing software application 101 to perform a time-wise snapshot of the executing software application 101 to thereby limit the amount of data generated, yet provide a more comprehensive view of the executing software application 101. The function polling system 107 includes a polling and data collection function 110 which periodically checks the software application 101 to determine which function is presently executing within the software application 101. The periodic polling of executing processes significantly reduces the amount of data collected, yet enables the application stakeholder to obtain a granularity of data relating to the executing software application 101 not available with existing software monitoring systems 103. The function polling system 107 monitors all the functions embodied in the software application rather than selected functions to thereby avoid gaps in the coverage of the monitoring. Furthermore, the function polling system 107 includes one or more software specific modules 111-112 that translate the collected information into terms that relate to the specific software application 101 and which make sense to a application stakeholder.

Difference from Tracing

Presently, access to a large amount of function data can be achieved by simply tracing all of the processes that execute in a software application. This typically provides an enormous amount of data detailing the operation of each and every function that is utilized by the software application. This tracing process provides more data to the application stakeholder, but has significant drawbacks. First, the tracing process is implemented on each and every executing software application process which places a significant load on the processor. Second, the tracing process collects so much data that it is excessive to manage. The function polling system 107 does not collect complete data but instead periodically samples the data. Third, the data collected by the tracing process is done exclusively on a per software application process basis and it is difficult to generate reports across software application processes. The function polling system 107 allows for reporting across processes.

### EXAMPLE APPLICATION

An example of a simple process is provided to illustrate the functionality of the function polling system 107. The following is a high-level presentation of the functions in an order processing application:

```
Main (the top level function, starts and stops the process)
    ProcessOrder
        ComputeTotal*
            ComputeServicesTotal
            ComputeProductsTotal
        TranslateToUSDollars
        PrintInvoice *
            PrepareDataForPrinting
            BeginDialogWithPrinter
            SendDataToPrinter
            WaitForPrinterReturnCode
The functions with the “*” have been exposed to through the proprietary reporting Application Interface 102 for this software application 101.
```

At any moment in time, the executing software application 101 is only performing one function at a time. The process call stack, located in the computer system (not shown) on which the software of FIG. 1 runs, maintains a listing of all of the functions that are active to serve the executing function of the software application 101. Thus, the execution of a nested function produces a listing of not only the executing function, but also all of the functions higher up in the hierarchy of functions to the software application itself. For example, if the software application noted above was in the process of computing the products total by executing the function ComputeProductsTotal, then the process call stack would look like this:

```
Main
    ProcessOrder
        ComputeTotal
            ComputeProductsTotal
```

Given this example and the limited number of functions exposed to the application stakeholder through the proprietary reporting Application Interface 102 for this software application 101, here are some of the problems:

Blind Spot Problem

If the function ComputeProductsTotal has not been exposed through the proprietary reporting Application Interface 102 for this software application 101, it is a blind spot. What if the function TranslateToUSDollars normally takes a few milliseconds but recently started taking 5 minutes? Since the performance statistics of the function TranslateToUSDollars are not revealed, the application stakeholder cannot see that the performance slow down is a new problem located external to the ComputeTotal function and not some function nested within the exposed function ComputeTotal. The lack of a complete picture that provides a listing of all functions that are at the same level of the function hierarchy contained of the software application 101 provides voids in the reporting data that cannot be resolved by the application stakeholder.

Granularity Problem

If the PrintInvoice function, which is exposed via the proprietary reporting Application Interface 102 for this software application 101, is slow, how it this problem fixed? Since the PrintInvoice function is made up of four, low-level functions, it is difficult to determine a solution, since it can be one or more of these low-level functions that could be the source of the problem. Is the SendDataToPrinter Function the problem? If so, the network that serves to interconnect the processor to the printer may be the problem, not the software application 101 or the PrintInvoice function itself.

Is the PrepareDataForPrinting Function the problem? If so, the internal computer drivers for the existing suite of printers that are connected to the network that serves to interconnect the processor to the printers may be incorrect.

Absent a level of granularity that provides the application stakeholder with the complete picture of all of the functions that are present in the software application 101 at each level of the hierarchy of functions that comprise the software application 101, the application stakeholder has insufficient data to analyze the operation of the system and efficiently resolve problems that occur.

System Architecture

The function polling system 107 is capable of monitoring any executing software application 101 and both uses the proprietary reporting Application Interface 102 of the software application 101, as needed, while also bypassing the proprietary reporting Application Interface 102 to directly poll the executing software application 101 to perform a time-wise snapshot of the executing software application 101 to thereby limit the amount of data generated, yet provide a more comprehensive view of the executing software application 101. The function polling system 107 includes software specific modules 111-112 that translate the collected information into terms that make sense to a specific user.

For example, a database management system such as the Oracle database may have ten thousand pieces of code. The Oracle Application Interface 102 may only expose two hundred statistics. The function polling system 107 is able to track how much time is spent in each function. The application stakeholder may set the polling interval and which software applications 101 are monitored. In many cases, the polling interval may be many times per minute. For example, if the polling interval is set for 10 times per minute and the software applications 101 are set to the Oracle database, then the processes of the Oracle database will be polled 10 times per minute to determine where the processes are currently in the call stack. The processes to be monitored can be filtered by various different methods such as the user running the process or the type of process.

Operating Architecture

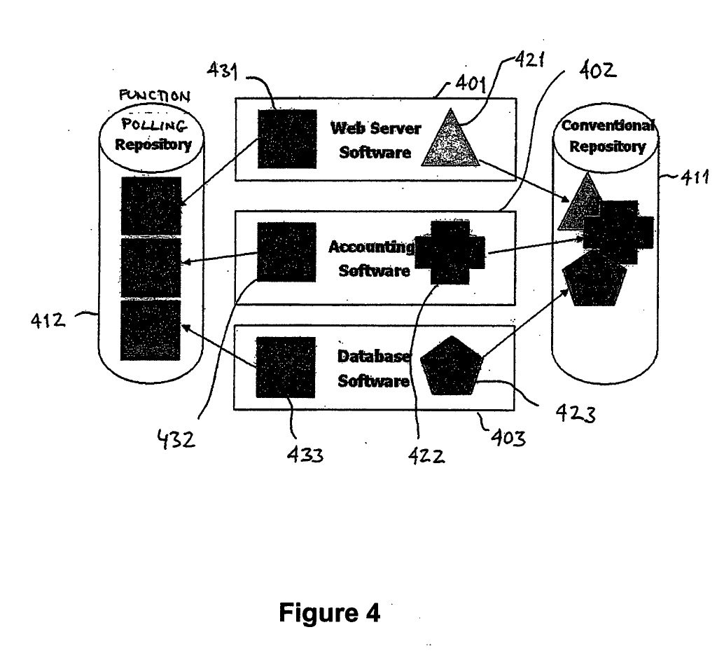

FIG. 4 illustrates, in block diagram form, the operating architecture of the function polling system, compared to existing conventional monitoring repositories for the example of a plurality of software applications or processes 401-403 running on a processor (not shown). A data repository 411/412 is the single place where the statistics from all of the processes 401-403 are stored. In the existing third party software reporting applications 103, the data generated by the processes 401-403 are used by the Application Interface 102 to generate report data 421-423, which is stored together by the existing third party software reporting applications 103 in a single repository 411. In contrast, the function polling system 107 takes the report data generated by the Application Interface 102 and/or data directly retrieved from the process call stack of each process 401-403 to form statistics data 431-433 which are stored individually in the data repository 412 to thereby enable the separate analysis of the statistics data 431-433.

One of the huge benefits of this method of tracking the statistics for a plurality of processes is that the process call stack data for all running processes 401-403 essentially looks the same and this data can be stored in similar ways. This is helpful when analyzing data across the layers 401-403 of a single software application. FIG. 4 shows how this differs in storage/analysis. Since existing third party software reporting applications 103 are using the Application Interface 102, which is different for every software application 101 and possibly each process in the software application 101, they get different data 421-423 from each process 401-403 and have a hard time reporting on this different data. On the other hand, since the function polling system 107 collects information in the same way for each process 401-403 in the software application 101 using a program call stack, the data format is always the same, making reporting across the software applications 101 much easier, especially since the statistics data is organized by executing process.

An example will help illustrate how the function polling system 107 works. Assume that the layers 401-403 in FIG. 4 refer to the layers of an end-user accounting application. The application user would access a web-based interface (the web server layer 401), and the web server layer 401 communicates with the accounting software layer 402, which has the business logic for the processing. In turn, the accounting software layer 402 communicates with the database software layer 403 to retrieve the data that is stored in a database 404. Together, all three software layers 401-403 work to provide the processing the user requires. Assume that the layers 401-403 of this software process each have the following functions of code:

| Web Server Layer Software | |
|---|---|
| Main (the top level function, starts and stops the process) | |
| AcceptWebPageRequestFromUser | 2 seconds |
| RetrieveOrderFromAccountingSystem | 51 seconds |
| BuildWebPage | 1 second |
| EncryptWebPageForSecurityPurposes | 5 second |
| SendWebPageToUser | 1 second |

TOTAL TIME SPENT IN LAYER=60 seconds, is also the time the user waited for the application to process the request

| Accounting Layer Software | |
|---|---|
| Main (the top level function, starts and stops the process) | |
| RetrieveOrder | |
| RetrieveDataFromDatabase | 30 seconds |
| ComputeTotal* | |
| ComputeServicesTotal | 12 seconds |
| ComputeProductsTotal | 8 seconds |
| TranslateToUSDollars | 1 second |

TOTAL TIME SPENT IN LAYER=51 seconds, should match time spent in RetrieveOrderFromAccountingSystem (from Web Server Layer)

| Database Layer Software | |
|---|---|
| Main (the top level function, starts and stops the process) | |
| DataRequest | |
| AcceptDataRequest | 1 second |
| DetermineDataLocationOnDisk | 2 seconds |
| RetrieveDataIntoMemoryFromDisk | 14 seconds |
| SendDataToUser | 3 seconds |

TOTAL TIME SPENT IN LAYER=30 seconds, should match time spent in RetrieveDataFromDatabase (from Accounting Layer Software)

Assume that it typically takes 60 seconds to process an order through this web-based application. Also assume that the polling agents of the function polling system 107 are set to poll one time every second each of the three running processes 401-403 representing each layer. In this case, the polling agents would collect the follow number of process call stacks:
Web Server Layer Software—60 process call stacks captured
Accounting Layer Software—51 process call stacks captured
Database Layer Software—30 process call stacks captured.
   Since the polling interval was 1 second, the agents assume that the function being executed at the split second the agent was polling the process, was executing the entire 1 second even though this may not actually be true.

Some of the important output that is usable to the application stakeholders is the time spent on each function and/or sub-function. Here are two examples of how this data can be used.

If performance is abnormally poor, the application stakeholder can look at historically collected data and see which function or sub-function is taking longer than it's usual time.

For budgeting purposes, an executive may view the data and determine where to spend time and money to improve application performance. For example, if most of the time is being spent in the database layer 403, the executive may decide to hire a database expert to optimize the database or a faster database server may be purchased. On the other hand, if most of the time is spent in the web server layer 401, then a web server expert may be hired or a faster web server may be purchased.

In any case, each executing process 401-403 is polled to retrieve data from the process call stack to determine the operational state of each sub-function in the process. This granularity of data enables the application stakeholder to understand the temporal interrelationship of the processes and sub-functions within the processes, to thereby analyze the execution of the software application and identify any problems with the execution of the software application.

A Comparison of the Existing Technology with the Function Polling System

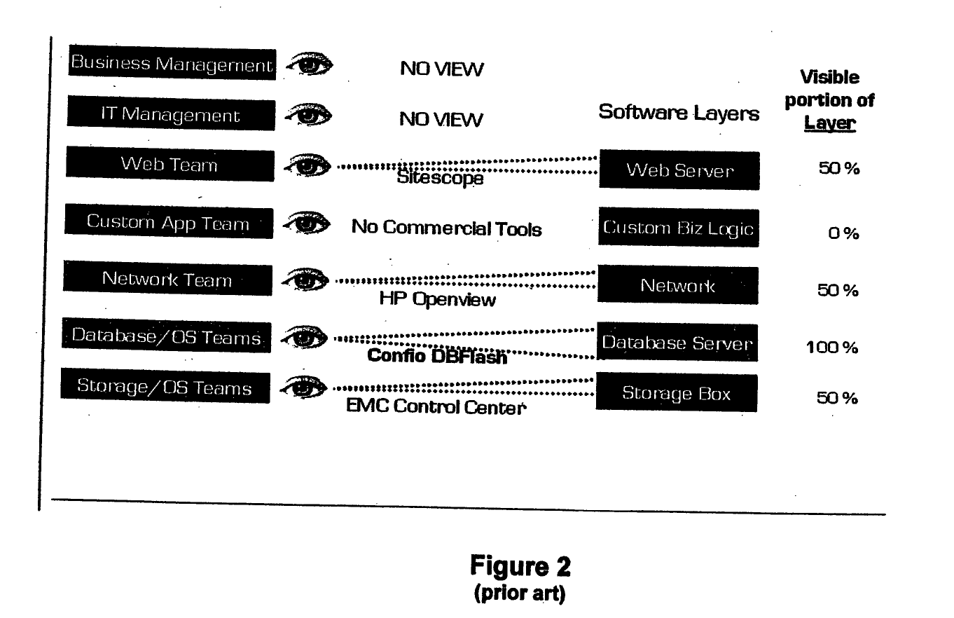

In order to facilitate the business processes of an organization, the various functional units (teams) of the organization must have access to the business information of the organization. The business information generally corresponds to a particular layer or layers of the corresponding Information Technology (IT) system. This typically entails having each team using a tool of their choice to monitor their own layer. FIG. 2 illustrates, in block diagram form, the capabilities of existing software application monitoring systems and how they are used by various teams to view various corresponding layers of the IT system.

Business User—Only concerned with how the application performs. They don't know (or care) which IT layer/group is responsible for poor performance.

Business Management—Wants to verify that business processes are adequately supported by IT with minimal spending. Interested in understanding how IT successes and failures affect the company financials.

IT Management—Interested in ensuring that the technical infrastructure is performing adequately to support the business. Attempts to do so with a limited budget and must often prove necessity of expenditures. Presently, IT managers have limited tools available to view the performance of the IT system. Without proper tools, IT Management often throws expensive hardware at the problem.

IT Staff—The staff is often split into groups supporting different layers of the application stack. Each group is focused almost solely on that layer with very limited views into other layers. This segmentation often results in problems that go unresolved since no one is really sure where the problem resides. Existing layer-specific tools only imply that the monitored layer is not the problem. Due to the tool's incomplete view of the layer, in some cases, the tool incorrectly implies that the layer is performing well. Existing tools are indicated on FIG. 2 and show the correspondence between the various teams and the layer of the IT system that is monitored by the existing tool.

As can be seen from FIG. 2, there are software application monitoring tools available, but these most provide a limited view of only a single layer of the IT system and at that typically only provide a view of a fraction of the monitored software application. There are tools available that also monitor many layers but through the Application Interface 102, so they are able to show all, or most, layers but have limited insight into the layer due to the Application Interface 102 limitation.

The Long-Term Solution

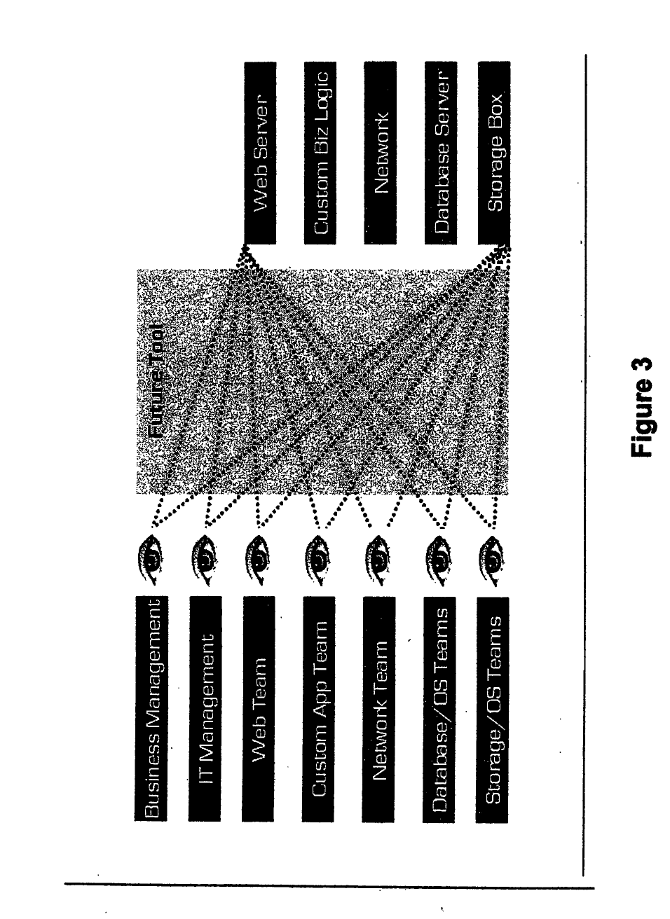

FIG. 3 illustrates, in block diagram form, the capabilities of the present function polling system 107. With the function polling system 107, all of the teams see complete statistics for all the layers of the IT system and the dependencies among the layers. For example, the team responsible for the WEB servers not only sees complete statistics for the WEB servers but also complete statistics for the network, database, and the other layers. When a business user contacts any of the teams, the user will be quickly routed to the appropriate group eliminating the common finger pointing among groups. All the groups can see exactly where the problem lies. The business and IT management teams also see the full picture. With everyone on the same page, it is easy to gain consensus on where to focus financial and IT resources.

Capability Comparison

The following table compares various aspects of existing software application monitoring systems and the present function polling system:

| Present Technology | Function Polling System |
|---|---|
| Uses monitored software vendor | Bypasses API, uses common software |
| incomplete API | architecture |
| Can reuse 10% of code between | Can reuse 90-95% of code between |
| modules | software application monitoring |
| | modules |
| Incomplete API produces | Architecture produces complete |
| incomplete statistics | statistics |
| Statistics isolated to one IT group | Statistics shared across organization |
| Unable to monitored custom | Able to monitor any software |
| applications | application |
| Need cooperation from | No cooperation needed |
| monitored software vendor | |
| Limited end-to-end monitoring for | Complete end-to-end monitoring for |
| some applications | all software applications |

The following is an example of a fictional company that might use the function polling system 107 to monitor their database system. Our fictional company called ABC Corp. makes and sells widgets. The company stores all permanent and transitional data inside of their database. Virtually all medium or large businesses like ABC Corp. store the majority of their mission-critical data inside of databases. The database may have many types of users performing many types of functions. For example, ABC Corp. has:

Order entry clerks entering new orders into the database
Purchasing clerks viewing order information to determine what supplies need to be restocked
Managers running sales reports against the database
Manufacturing computers determining how to run the assembling line
Shipping clerks printing out shipping labels

A typical large database may have thousands of users all performing these types of operations at the same time. The function polling system 107 goes into the database and takes a rapid picture of what resource each user is presently using. One user may be using the Central Processing Unit, another user may be using a certain disk drive, while another user may be waiting to send information over the network. There are thousands of different resources that may be used by these processes. The function polling system 107 tells the database administrator where the processes are spending their time. The agent software can poll the database many times every second with very little overhead. By giving the database administrator a view of how each process is spending time on each resource, the database administrator can then determine which processes need to be tuned.

The polling agents normally run twenty-four hours a day/seven days a week. This allows the database administrator to review these statistics during a past problem period. For example, ABC Corp has a nightly batch job that processes all the orders received during the day and generates a sales report for management to review. Although the report normally finishes in two hours, it took four hours during the previous night's run. The database administrator can use the function polling system to review all the statistics during that period to determine the cause of the problem and the proper solution. First, the function polling system can detect if a problem is starting to occur and show the user how to stop the problem before it has a major impact. Second, if a problem occurs, the function polling system 107 records exactly what happened during the problem so the user does not have to wait for the problem to occur again before diagnosing the issue. Presently, many database administrators have to be monitoring the database when the problem occurs or they cannot determine the problem. This is the benefit of having an historical 24/7 monitoring solution.

Prioritize Tuning Tasks

A typical database may have literally thousands of different items to tune. Without a tool like the function polling system 107, it is nearly impossible for the database administrator to tell which items should receive attention. The function polling system 107 prioritizes the tasks so the database administrator can spend time on the items that can be tuned to provide the most benefit to the application.

Reduced Hardware/Software Upgrade Costs

The function polling system 107 displays tunable bottlenecks that, when fixed, can postpone or eliminate the need for additional hardware or software.

Improve Service Level Quality

The function polling system 107 allows businesses to comply with Service Level Agreements (SLA). For example, a large insurance company has an SLA that guaranteed that the amount of processing time required to enter a new policy would be less than three seconds. If the process was currently taking approximately six minutes, this exceeds the SLA by 120,000%. The function polling system when applied to this application could show the company how to reduce the processing time by over 90% within days of installation.

Employee Education

The function polling system 107 exposes the internals of the software applications 101. Application stakeholders report learning more about the internal workings of the software while using the function polling system than they have learned taking many classes. This education is even more relevant since the function polling system “teaches” about the specific problems facing the application stakeholders rather than hypothetical classroom issues.

Fewer Application stakeholders Perform the Same Amount of Work

The recent economy has forced management to reduce staff thus creating teams that are understaffed and overworked. The function polling system helps the application stakeholders perform work in the most efficient method possible so additional staff needs are reduced.

### SUMMARY

The function polling system periodically checks the software application to determine which function is presently executing within the software application. The periodic polling of executing processes significantly reduces the amount of data collected, yet enables the application stakeholder to obtain a granularity of data relating to the executing software application not available with existing software monitoring systems.

1. A system for monitoring operation of a software application that executes on a processor, comprising:
polling means, connected to said software application, for polling said software application to retrieve statistics data indicative of operation of said software application; and
data repository means for storing said retrieved statistics data.

2. The system for monitoring operation of a software application of claim 1 further comprising:
means for periodically activating said polling means.

3. The system for monitoring operation of a software application of claim 1 wherein said software application comprises a plurality of processes, said polling means comprises:
means for determining which processes of said software application are presently executing within said software application.

4. The system for monitoring operation of a software application of claim 3 wherein said determining means comprises:
means for retrieving statistics data directly from the process call stack of each of said processes.

5. The system for monitoring operation of a software application of claim 3 wherein said polling means comprises:
means for monitoring all the processes embodied in the software application.

6. The system for monitoring operation of a software application of claim 1 wherein said software application comprises a plurality of processes, said data repository means comprises:
means for storing statistics data from all of the processes presently executing within said software application.

7. The system for monitoring operation of a software application of claim 1 wherein said data repository means comprises:
means for storing said retrieved statistics data individually in the data repository to thereby enable the separate analysis of the statistics data.

8. A method for monitoring operation of a software application that executes on a processor, comprising:
polling said software application to retrieve statistics data indicative of operation of said software application; and
storing said retrieved statistics data in a data repository.

9. The method for monitoring operation of a software application of claim 8 further comprising:
periodically activating said polling means.

10. The method for monitoring operation of a software application of claim 8 wherein said software application comprises a plurality of processes, said step of polling comprises:
determining which processes of said software application are presently executing within said software application.

11. The method for monitoring operation of a software application of claim 10 wherein said step of determining comprises:
retrieving statistics data directly from the process call stack of each of said processes.

12. The method for monitoring operation of a software application of claim 10 wherein said step of polling comprises:
monitoring all the processes embodied in the software application.

13. The method for monitoring operation of a software application of claim 8 wherein said software application comprises a plurality of processes, said step of storing said statistics data in said data repository comprises:
storing statistics data from all of the processes presently executing within said software application.

14. The method for monitoring operation of a software application of claim 8 wherein said step of storing said statistics data in said data repository comprises:
storing said retrieved statistics data individually in the data repository to thereby enable the separate analysis of the statistics data.
